(19) United States
(12) Patent Application Publication
(10) Pub. No.: US 2004/0004084 A1
(43) Pub. Date: Jan. 8, 2004

(54) Dispenser with resilient display bottom

(76) Inventor: Christer Johansson, Knista (SE)

Correspondence Address: YOUNG & THOMPSON, 745 SOUTH 23RD STREET 2ND FLOOR, ARLINGTON, VA, 22202

(21) Appl. No.: 10/363,304

(22) PCT Filed: Aug. 31, 2001
(86) PCT No.: PCT/SE01/01846

(30) Foreign Application Priority Data
Sep. 1, 2000 (SE) 0003093-2

(51) Int. Cl. B65H 3/00; G07F 11/00

(52) U.S. Cl. 221/194

(57) ABSTRACT

The invention suggests a dispenser structure with a storage space in vertical orientation, defined by four upright walls and a bottom. A dispensing orifice is defined between the bottom and a lower rim of a front wall supported on in the dispenser structure. The bottom is made of resilient material, such as nature rubber or synthetics, and totally resilient when a pressure is manually applied to either side of the bottom. The resilient bottom covers the sectional area of the dispenser, and reaches forwards in front thereof for displaying article that are made freely accessible by manipulation of the resilient bottom.

### TECHNICAL FIELD

The invention relates to dispensers having a front opening for dispensing articles according to the preamble of claim 1. More specifically, the invention relates to a dispenser having an orifice, the height of which is locally and momentarily adjustable by manually applying a pressure to a resilient bottom element of the dispenser.

### BACKGROUND AND PRIOR ART

Dispensers are known for-storage and display of articles resting on a bottom surface that is slanting downwardly/forward. A dispensing orifice is formed between the bottom surface and the lower rim of a front wall included in the dispenser structure. Articles, stored in the dispenser, are advanced by gravity to rest behind a front stop that is formed in the outer end of the bottom surface. This type of dispensers may be used in self-service magazines for dispensing unwrapped candy, in seed dispensers, etc.

Other articles that are stored in dispensers include bolts, nuts, washers and any other small sized details for assembly work in industrial production and assembly lines. These articles are often cornered or edged and tend to frictionally stick together when piled in a storage condition. For this reason it is often a problem to control the dispensed volume, which is related to the height of the orifice of the dispenser. This problem frequently causes a deadlock in the orifice that interrupts the operation of the dispenser. Dispensers are already known, wherein a rigid bottom surface is pivotable for individually dispensing a singular article, such as the clothespin of U.S. Pat. No. 2,680,663 or the cigarette of U.S. Pat. No. 2,435,793. In the first mentioned document, a scoop-formed tray is restrained in the lowering motion for dispensing the clothespins one at a time through the dispenser orifice. In the other document, a restrainer is activated in the lowering motion of the dispenser bottom for detaching the cigarettes one at a time. Dispensers are also known with a sliding front wall by which the height of the dispensing orifice is adjustable, such as the device of U.S. Pat. No. 4,037,756 for dispensing articles that are wrapped in packages and stored in an organized manner for a magazine feed.

None of these known dispensers addresses the problem of a deadlock occurring in the orifice and which is related to the dispensing of smaller sized articles having irregular shapes, and being stored in a disorganized manner.

### SUMMARY OF THE INVENTION

An object of this invention is to avoid the problem of articles clogging in the orifice of a dispenser that is adapted for the dispensing of smaller sized articles, stored in a disorganized manner in the dispenser.

Another object is to provide a dispenser wherein the dispensing of articles in desired quantities is facilitated through the manipulation of a resilient dispenser bottom.

These and other objects are met with a dispenser as defined in claim 1. Embodiments of the invention are defined in the subordinated claims.

Briefly, the invention suggests a dispenser for storage and dispensing of articles, the dispenser comprising a vertically oriented storage space that is defined within longitudinal walls on four sides and having a dispenser bottom onto which the articles are advanced to be dispensed through an orifice, said orifice having a height dimension defined between the bottom and a lower rim of a front wall of the dispenser. The dispenser bottom has a resilient bottom member covering the sectional area of the storage space, and a forward portion of the dispenser bottom reaching in front of the dispenser for receiving articles that are dispensed from the orifice. The resilient bottom member is supported by a frame that connects to a bottom end of the dispenser structure, the frame being arranged for shaping the forward end of the resilient bottom member into a stop for retaining the dispensed articles to be freely accessible from the forward portion of the resilient bottom member. In the dispenser, structured as defined above, the dispenser orifice is locally and momentarily adjustable in respect of the height dimension through a pressure that is manually applied from under or above the resilient bottom member in order to prevent or to undo clogging of articles in the orifice.

Advantageous embodiments may comprise a resilient bottom member having a structured, frictional surface. Preferably, the resilient bottom member is made from synthetic or nature rubber, or any other synthetic or plastic material having similar resilient properties. Also, the dispenser, structure advantageously has a front wall that is slidably supported for setting an initial dimension of the orifice height.

### SHORT DESCRIPTION OF THE DRAWINGS

The invention is further disclosed below with reference made to the attached drawings, wherein

FIG. 1 is a diagrammatic, partial section showing a conventional dispenser,

FIGS. 2a and 2b are corresponding diagrammatic views showing the principles of the present solution,

FIG. 3 is a front elevation view showing an embodiment of the dispenser having a resilient bottom member,

FIG. 4 is a plan view showing the dispenser with resilient bottom member from above, and

FIG. 5 is a sectional view showing the resilient bottom member.

### DETAILED DESCRIPTION OF THE INVENTION

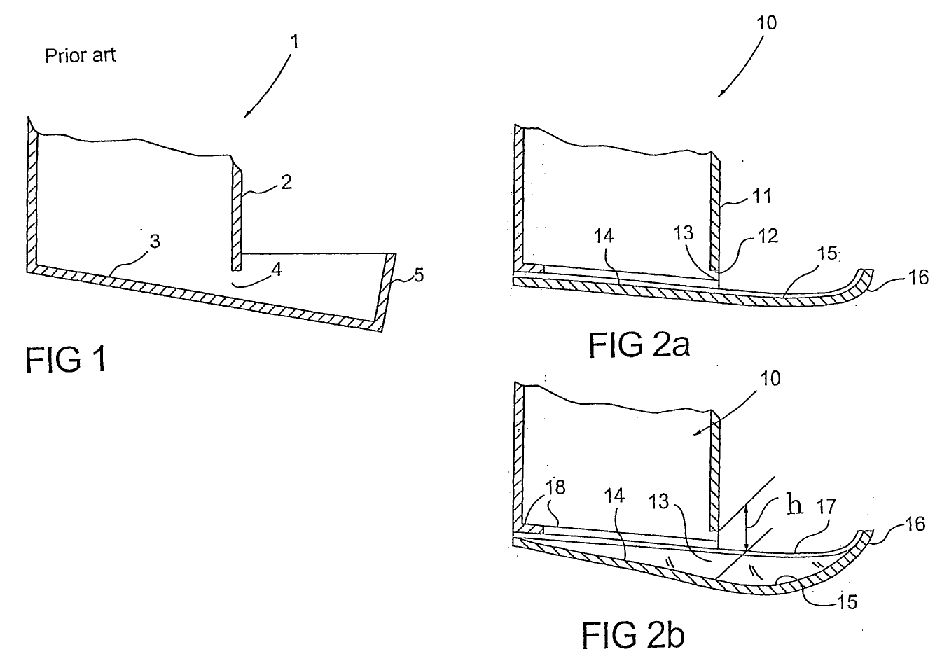

With reference to FIG. 1 a conventional dispenser 1 is described. The dispenser 1 has a vertically oriented storage space, enclosed by four walls including a front wall 2. A downwardly/forward slanting bottom 3 is arranged with a gap to a lower rim of the front wall 2 for providing a dispensing orifice 4 through which the articles are successively dispensed for access. The articles rest onto the bottom 3 and are forced by gravity to slide or roll towards a stop 5, arranged in the forward end of the bottom 3.

It will be understood that the dispensed volume and feed rate of articles is related to article size and shape, the height of the dispenser orifice, and the slope angle of bottom 3. Occasionally, a clogging of the orifice may occur especially if the articles are cornered and edged, and stored and dispensed in a disorganized manner. This is often the case when the dispenser is used for the storage and dispensing of bolts, nuts, washers and similar, irregularly shaped articles.

With reference to the diagrammatic drawings of FIGS. 2a and 2b the present solution will be described. A dispenser 10 has a vertically oriented storage space, enclosed by four walls including a front wall 11. A lower rim 12 of the front wall forms the upper limit of a dispenser orifice 13, through which articles are successively dispensed for access. The articles rest onto a bottom 14 that is connected to the back and side walls of the dispenser. The bottom 14 may be arranged in a downwardly/forward slanting orientation, and is spaced from the lower rim 12 for defining the lower limit of the orifice 13. A front end of the bottom 14 reaches forward from the orifice to receive and display the dispensed articles in a position where they are freely accessible.

The bottom 14 is made from a resilient material (as used herein, the expression resilient material shall be understood as defining a material with ability to recover shape quickly when a deforming force or pressure is removed), such as a plastic or other synthetic material, or most preferred, from nature rubber. A protruding area. 5 of the bottom 14 is dimensioned to receive the dispensed articles and has a forward end that is formed to provide a stop 16 for retaining the articles in accessible position. In FIG. 2a the dispenser 10 is shown in storing mode, where the bottom 14 is in a neutral position. A frame 17, fork-shaped in a plan view, connects to the bottom end of the dispenser 10 and adjoins the margins of bottom 14 for holding the resilient bottom, and for curving the forward end thereof upwardly, to form the stop 16.

For dispensing articles through the orifice 13, or in order to undo a clogging of articles in the orifice, a pressure is manually applied to the resilient bottom 14. The pressure is typically applied from above in order to locally and momentarily depress the bottom 14 and thereby to locally and momentarily increase the height h (see FIG. 2b) of the orifice 13. Alternatively, the pressure is applied from under the bottom for locally lifting the resilient bottom 14. When the pressure is removed, the bottom quickly returns to the neutral position due to the resiliency of the material in bottom 14. However, the locally and momentarily applied pressure will be sufficient for dislocation of the articles that were previously clogged in the dispensing orifice.

The initial orifice height h may be adjustable through a front wall that is slidably connected to the dispenser structure. By properly setting the initial orifice height in relation to the size of the articles, the resiliency of bottom 14 may be used for controlling the volume and feed rate of articles to be suspended, by controlling the locally applied pressure. Also, the upper surface of resilient bottom 14 may be structured or textured in order to frictionally engage the articles that are received on the surface.

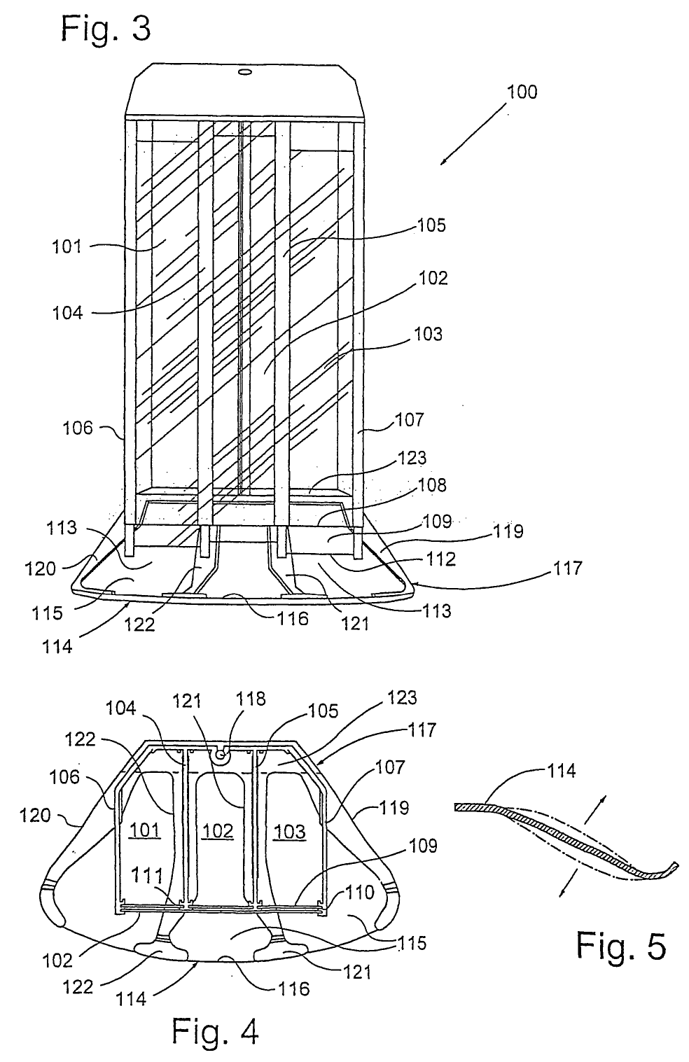

The suggested dispenser having a resilient bottom 14 may be realized in detailed embodiments, all taking advantage of the flexible dispenser orifice. A preferred embodiment of the dispenser is shown in FIGS. 3-5.

FIG. 3 is a front elevation view and FIG. 4 a plan view from above, showing a dispenser structure 100 defining three storage spaces 101, 102 and 103. The structure 100 is an extruded aluminum element having two partition walls 104,105 running in parallel between side walls 106,107. The longitudinal margins of a translucent front wall 108 is received in slots, running in the outer ends of each side wall. Each storage space has a separate and translucent compartment wall 109, arranged behind the front wall 108 and slidably received in slots 110 and 111 formed in the ends of side walls 106, 107 and partition walls 104,105, respectively. The compartment walls each have a lower rim 112, defining the upper limit of dispensing orifices 113, respectively.

As best seen in FIG. 4, a resilient bottom 114 is attached to cover the sectional area of dispenser structure 100. A protruding area 115 reaches in front of the orifice 113 for receiving the articles that are dispensed through the orifices 113. A forward end of the bottom 114 is formed to provide a stop 116 for the articles in a freely accessible position on the bottom surface.

A resilient element of bottom 14 is supported by a fork-shaped frame 117, and preferably adhered to the underside thereof by gluing. The frame 117 is attached to the bottom end of the dispenser structure 100, e.g. through a bolt in threaded engagement with a channel 118 that is formed longitudinally in the extruded dispenser structure. Side arms 119,120 of the fork 117 connects to bottom ends of the side walls 106,107 of the dispenser structure 100. The frame 117 is formed with fingers 121,122 that reach forward from a transverse connecting portion 123. The fingers 121,122 connect to bottom ends of the partition walls 106,107 for defining the separate bottom areas of each compartment or storage space 101,102,103. The fingers 121,122 reach forward of the dispenser structure to provide the areas 115 from where the articles, dispensed through the orifices 113, are accessible to the user. As is best seen in FIG. 5, the outer ends of the side arms 119,120 are curved inwards and bent slightly upwards, and the fingers 121,122 are laterally widened and bent upwards for shaping the outer end of resilient bottom 114 to the stop 116 that retains the dispensed articles within the resilient areas 115. In FIG. 5, the dash-dot lines and arrows illustrate the bottom member being locally manipulated from under or from above, respectively.

The dispenser 100 shown in FIGS. 3-5 is merely one example of realization of the disclosed solution for avoiding and undoing a clogging of articles in the dispenser orifice. The technical effect, as understood, relies on the resilient bottom member through which the orifice height may be locally and momentarily manipulated and varied, rather than any static adjustment of the orifice height per se. Also, the resiliency of the bottom member seems advantageous in that the articles that stick together in a deadlock are subjected to a shock effect, as the bottom member is first pressed and then hastily returns to the non-pressed condition.

1. A dispenser (10; 100) for storage and dispensing of articles, the dispenser comprising a vertically oriented storage space that is defined within longitudinal walls on four sides and having a dispenser bottom (14;114;117) onto which the articles are advanced by gravity to be dispensed through an orifice (13;113), the orifice having a height (h) defined between the bottom and a lower rim (12;112) of a front wall (11;109) of the dispenser, characterized by
the dispenser bottom comprising a resilient bottom member (14;114) covering the sectional area of the storage space, a forward portion (15;115) of the dispenser bottom reaching in front of the dispenser for receiving articles that are dispensed through the orifice, and
the resilient bottom member being supported by a frame (17;117) that connects to a bottom end of the dispenser structure, the frame being arranged for shaping the forward end of the resilient bottom-member (14;114) into a stop (16;116) for retaining the dispensed articles to be freely accessible from the forward portion of the resilient bottom member, whereby
the dispenser orifice (13;113) is locally and momentarily adjustable in respect of the height (h) through a pressure that is manually applied from under or above the resilient bottom member (14;114).

2. The dispenser of claim 1, wherein the resilient bottom member (14;114) is formed to have a structured, frictional surface.

3. The dispenser of any previous claim, wherein the bottom member (14;114) is made from synthetic rubber or nature rubber.

4. The dispenser of any previous claim, wherein the orifice height (h) is initially set by means of a front wall (11;109) that is slidably supported on the dispenser structure.
